(19) United States
(12) Patent Application Publication
(10) Pub. No.: US 2016/0028856 A1
(43) Pub. Date: Jan. 28, 2016

(54) METHOD, SYSTEM AND APPARATUS FOR PROVIDING SERVICES ACROSS NETWORKS

(71) Applicant: miiiCasa Taiwan Inc., Taipei City (TW)

(72) Inventors: HUNG-CHUN KAO, New Taipei (TW); SHEN-JUNG CHAN, New Taipei (TW); TSE-YI LIN, New Taipei (TW); TSUNG-MIN LO, New Taipei (TW); YU-SHENG LIN, New Taipei (TW); KUANG-LIN HSIEH, New Taipei (TW); BO-TANG SHIAO, New Taipei (TW); TSUNG-HAN CHIN, New Taipei (TW)

(21) Appl. No.: 14/339,532

(22) Filed: Jul. 24, 2014

(51) Int. Cl. H04L 29/06; H04L 29/08

(52) U.S. Cl. CPC H04L 67/42; H04L 67/16; H04L 67/141; H04L 67/10

(57) ABSTRACT

The invention provides a method and a system for providing a service from a network device in a closed network to a client device outside of the closed network through a service portal. The method may include the steps of actively establishing a first connection between the network device and the service portal, receiving a request for the services from the client device via established first connection, retrieving data of service and sending back to the client device. As a result, the client device may access the service of network device in the closed network without being blocked by firewall or other security mechanism of the closed network. In addition, the service portal may also validate the client device, and therefore malicious intrusion or insecure access may be prevented.

### FIELD OF THE INVENTION

The present invention generally relates to network technology, especially a network device for providing services from a local area network (LAN) or an intranet to a wide area network (WAN), an extranet or the internet. On the other hand, the present invention provides a method and a system for retrieving services from an apparatus in a closed network to a terminal device in another network.

### BACKGROUND OF THE INVENTION

Generally, a server in a closed network such as a local area network (LAN) or an intranet may provide services only to the devices in said network. For accessing the services in the server, a client device in another network such as a wide area network, an extranet or the internet may connect with the server in the closed network through a virtual private network (VPN) by setting the VPN with the public IP address of the server.

However, in many cases, the public IP address of the server in the closed network may not be available for the client device to establish a VPN for connecting to the server. Therefore, the client device may not be able to connect with the server in the closed network. Moreover, the client device may be blocked by the firewall mechanism of the closed network and may not access the services in the server even though the public IP of the server is available for the client to establish a VPN for connecting to the server.

According to the above, what is needed is a method or a system using such method for a client device to access a server in a closed network especially when the client device is in another network. Therefore, the server in the closed network may provide its services to any devices outside of the closed network. In addition, a validation mechanism may also be needed for security reasons. As a result, the server in the closed network may provide servers to any devices outside of the closed network in a validated and a secure environment.

### BRIEF SUMMARY OF THE INVENTION

The invention provides a method for providing a service from a server device in a closed network to a client device outside of the closed network. The method maybe implemented in the server device and may include the steps of actively establishing a first connection between the server device and a management server outside of the close network, receiving a request for the services containing a first network address containing a virtualized host address of the services and a data path of the services in the virtualized host from the client device via the management server and through the established first connection, actively establishing a second connection to the client device, retrieving data of the services according to a second network address containing an actual host address of the services and the data path of the services and sending the data to the client device through the established second connection. As a result, the client device may access the service of the server device in a closed network without being blocked by firewall or other security mechanism of the closed network. In addition, the management server may also validate the client device for the server device, and therefore malicious intrusion or insecure access from the client device may be prevented. Hence, the server device may provide the services to devices outside the closed network without sacrificing security.

The invention also provides a system implemented in a network device in a closed network, wherein the system enables the network device to provide a service to a client device outside of the closed network. The system may control the network device to actively establish a first connection between the network device and a management server outside of the close network. The management server may provide a service page containing network addresses of services. The network addresses may contain a virtualized host address and data paths of the services in the virtualized host. The client device may send a request for the service containing the network addresses to the management server and the management server may pass the request to the network device through the established first connection. The system may retrieve the service according to the network addresses in the received request with the data paths and an actual host address generated from the virtualized host address, and then may control the network device to actively establish a second connection to the client device for providing the service to the client device through the established second connection. The network device may be any existing devices with network communication capability. Therefore, any existing device implemented with the system of the present invention may provide its services without being blocked by firewall or other security mechanism between the devices. In addition, the management server may also validate the client device for the server device, and therefore malicious intrusion or insecure access from the client device may be prevented. Hence, the server device may provide the services to devices outside the closed network without sacrificing security.

It should be understood, however, that this Summary may not contain all aspects and embodiments of the present invention, that this Summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIGS. 1A to 1E are schematic illustration of the network architecture according to embodiments of the present invention;

FIG. 1F is a block diagram of a network device according to one embodiment of the present invention;

FIG. 1G is a block diagram of an agent implemented within a network device according to one embodiment of the present invention;

FIGS. 2A to 2D are flowcharts illustrating the method for providing services in a network device to a terminal and retrieving data of services from the network device to the terminal according to embodiments of the present invention;

FIGS. 3A to 3D are flowcharts illustrating the method for providing services in a network device to a terminal and retrieving data of services from the network device to the terminal according to embodiments of the present invention;

FIGS. 4A to 4D are flowcharts illustrating the method for providing services in an application server from a network device to a terminal and retrieving data of services from the network device according to embodiments of the present invention;

FIGS. 5A to 5D are flowcharts illustrating the method for providing services in an application server 1000 from a network device to a terminal and retrieving data of services from the network device according to embodiments of the present invention;

FIG. 6 is a flowchart illustrating the method for providing services in the network device to a terminal according to one embodiment of the present invention;

FIG. 7 is a schematic illustration of a web page provided by the management server 200 or the terminal according to one embodiment of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

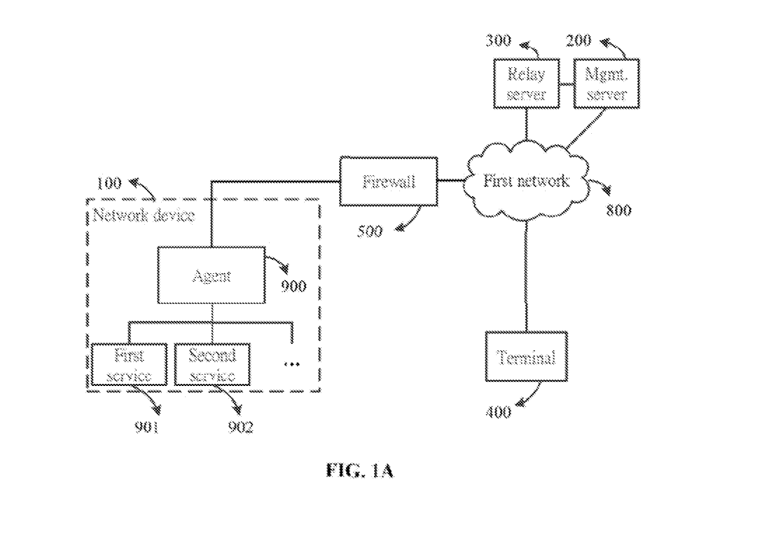

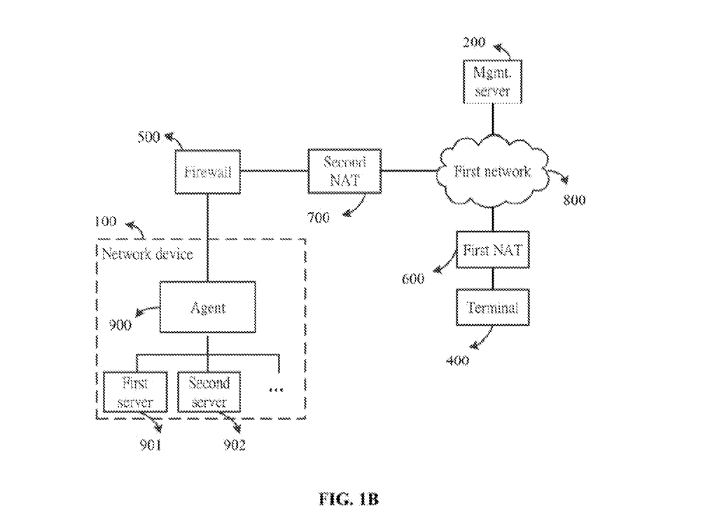

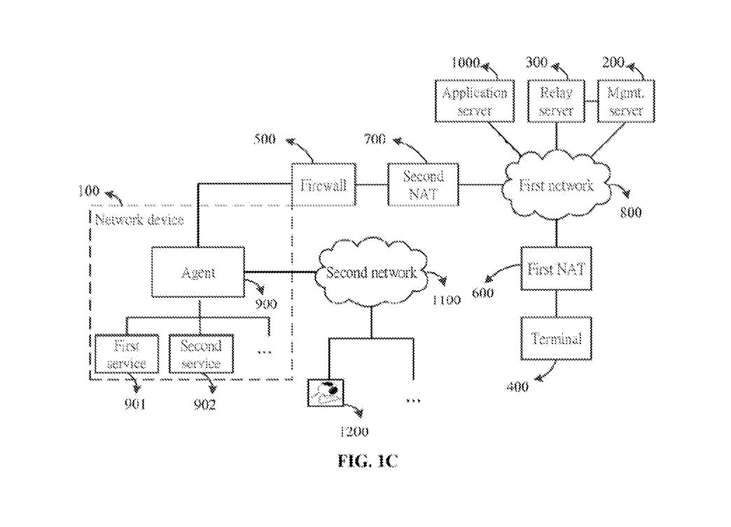

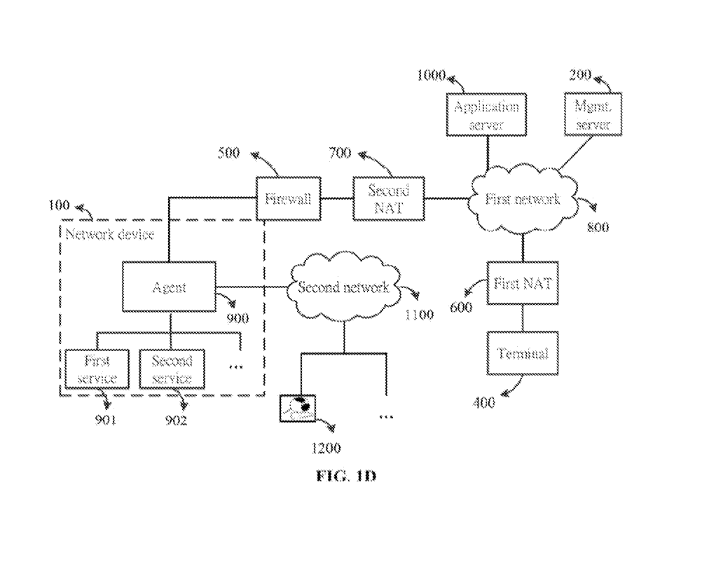

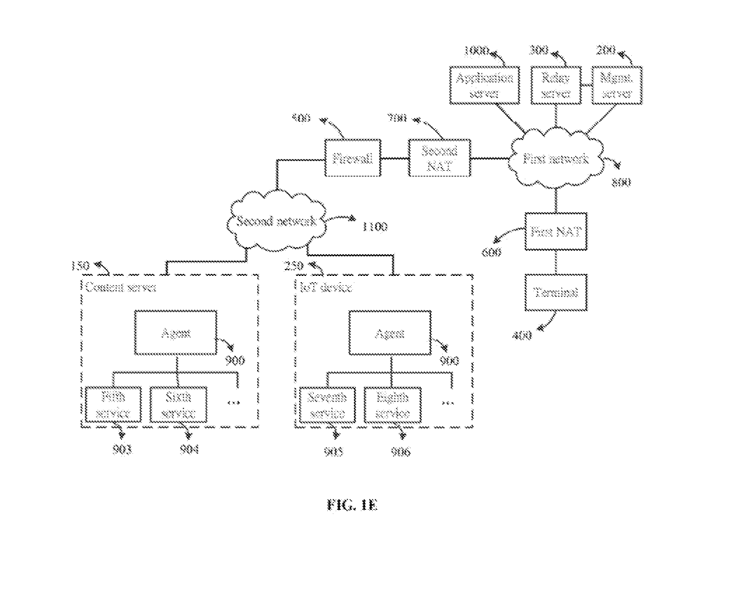

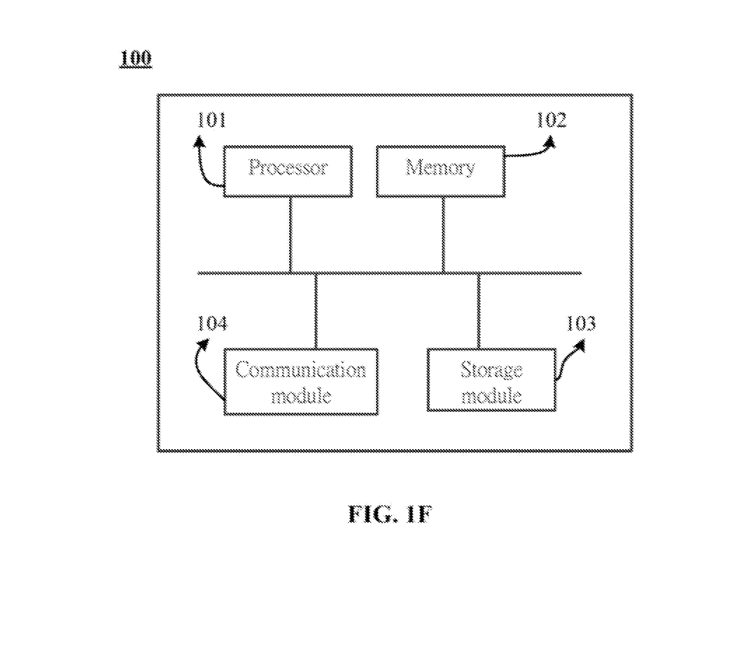

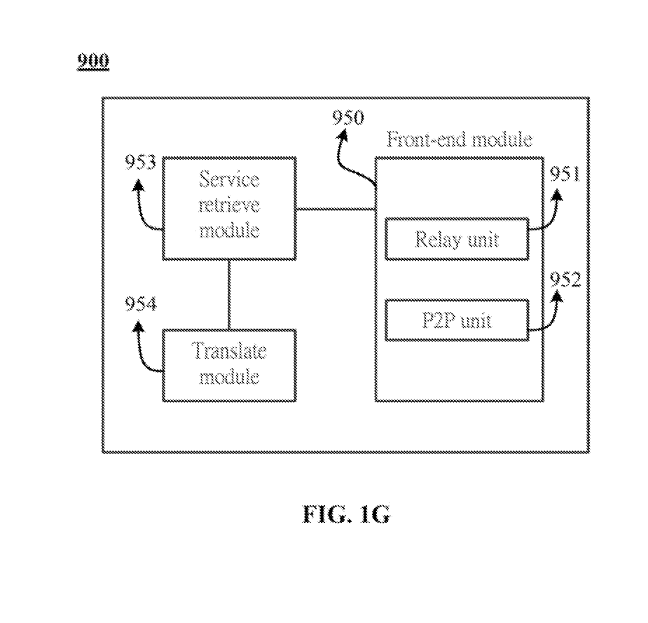

The description will be made as to the embodiments of the present invention in conjunction with the accompanying drawings in FIGS. 1A-7. Reference will be made to the drawing figures to describe the present invention in detail, wherein depicted elements are not necessarily shown to scale and wherein like or similar elements are designated by same or similar reference numeral through the several views and same or similar terminology. In accordance with the purposes of this invention, as embodied and broadly described herein, this invention,

FIGS. 1A to 1E illustrate the network architecture to one embodiment of the present invention.

Referring to FIG. 1A, a network device 100 may include an agent 900 for retrieving data of services available to the network device 100, such as a first service 901 and a second service 902. The network device 100 may connect with a first network 800 for providing services to devices in the first network 800. A management server 200 may connect with the first network 800 for providing a web portal of the services in the network device 100 to the terminal 400. In one embodiment of the present invention, the web portal of the services may comprise a web page containing network addresses of the services. The network addresses may comprise a virtualized host address representing the service portal and a data path of the services in the virtualized host (the service portal). The terminal 400 may send a request including at least one of the network addresses of the services to the management server 200. The network device 100 may take the initiative to establish a connection with the relay server 200 and keep said connection. The management server 200 may direct the request from the terminal 400 to the relay server 300. Therefore, the terminal 400 may request for the service from the relay server 300. The relay server 300 may further pass the request to the network device 100. Upon receiving the request from the relay server 300, the agent 900 in the network device 100 may translate the network address in the request by mapping an actual host of the request service to the virtualized host address and generating a new network address containing the actual host address and the data path of the service. The network device 100 may retrieve data of the requested service according to the generated new network address and send the data back to the terminal 400 via the relay server 300.

Referring to FIG. 1B, the network device 100 may connect with the first network 800 for providing services to the terminal 400. The management server 200 may connect with the first network 800 for providing a web portal of the services in the network device 100 to the terminal 400. In one embodiment of the present invention, the web portal of the services may comprise a web page containing network addresses of the services. The network addresses may comprise a virtualized host address representing the service portal and a data path of the services in the virtualized host (the service portal). The terminal 400 may send a request including at least one of the network addresses of the services to the management server 200. Thereby, the management server 200 may record the address of the terminal 400. In one embodiment of the present invention, the terminal 400 may also send its identification (the terminal ID) to the management server 200. The network device 100 may take the initiative to establish a connection with the management server 200 and may further send its identification (network device ID) to the management server 200. Thereby, the management server 200 may record the address of the network device 100. The management server 200 may send the address of the network device 100 to the terminal 400 and the address of the terminal 400 to the network device 100. In one embodiment of the present invention, management server 200 may further send the network device ID and the terminal ID to the network device 100 and the terminal 400 respectively for verification. Hence, the terminal 400 and the network device 100 may both take the initiate to establish a connection between each other data exchange without being blocked by the first network address translation device 600 (denoted as the first NAT 600) and the second network address translation device 700 (denoted as the second NAT 700). That is, the terminal 400 may send a request including the network address for the service to the network device 100 and the network device 100 may find and retrieve the requested service in the actual host of the requested service by finding an actual host address mapped to the virtualized host address and the data path of the service in the host. The network device 100 may further return the service via the established connection. The terminal device 400 may further display a user interface comprising the web page and the requested service to replace the corresponding network address in the web page.

Referring to FIG. 1C, the network device 100 may include an agent 900 for retrieving data of services available to the network device 100, such as the first service 901, the second service 902 and the services provided by the camera 1200 in the second network 1100. The network device 100 may connect with the first network 800 for providing the aforementioned services to devices in the first network 800. In addition, an application server 1000 may also connect with first network 800 so that its services may be available to the network device 100. The management server 200 may also connect with the first network 800 for providing a web portal of the services in the network device 100 and the application server 1000 to the terminal 400. The terminal 400 may send a request including a virtualized network address corresponding to the service available to the network device 100 in the web portal, wherein the service may be in the application server 1000, to the management server 200. The network device 100 may take the initiative to establish a connection with the relay server 300 and keep said connection. The management server 200 may further direct the request from the terminal 400 to the relay server 300. Therefore, the terminal 400 may send the request for the services to the network device 100 via the connection between the relay server 300 and the network device 100. The network device 100 may retrieve data of the services in itself, the application server 1000 or any devices in the second network 1100 according to an actual network address of server generated from the virtualized network address in the request and send back the data to the terminal 400 via the relay server 300. As a result, the network device 100 may collect services requested by the terminal 400 and provide to the terminal 400 in response to the request from the terminal 400.

Referring to FIG. 1D, the network device 100 may connect with the first network 800 for providing services available to the network device 100, such as the first service 901, the second service 902 and the services provided by the camera 1200 in the second network 1100. The application server 1000 may also connect with the first network 800 so that the services in the application server 1000 may also be available to the network device 100. The management server 300 may connect with the first network 800 for providing a web portal of the services in the network device 100 and the application server 1000 to the terminal 400. The terminal 400 may send a request including a virtualized network address corresponding to the service in the application server 1000 to the network device 100. Thereby, the management server 200 may record the address of the terminal device 400. In one embodiment of the present invention, the terminal device 400 may also send its identification (the terminal ID) to the management server 200. In addition, the network device 100 may take the initiative to establish a connection with the management server 200 and keep said connection. Thereby, the management server 200 may record the address of the network device 100. The management server 200 may send the address of the network device 100 to the terminal 400 and the address of the terminal 400 to the network device 100. In one embodiment of the present invention, management server 200 may further send the network device ID and the terminal ID to the network device 100 and the terminal 400 respectively for verification. Hence, the terminal 400 and the network device 100 may both take the initiate to establish a connection between each other data exchange without being blocked by the first NAT 600 and the second NAT 700. That is, the terminal 400 may send a request including the virtualized network address corresponding to the aforementioned service to the network device 100. The network device 100 may retrieve data of the services in itself, the second network 1100 or the application server 1000 according to an actual network address generated from the virtualized network address in the request and send the data back to the terminal 400 via the established connection. As a result, the network device 100 may collect services requested by the terminal 400 and provide to the terminal 400 in response to the request from the terminal 400.

Referring to FIG. 1E, a content server 150 or an internet-of-things (IoT) device 250 may include the agents 900 respectively for retrieving data of services requested by the management server 200, wherein a fifth service 903, a sixth service 904 may be in the content server 150, and wherein a seventh service 905 or a eighth service 906 may be in the IoT device 250. The content server 150 or IoT device 250 may take the initiative to connect with the first network 800 for providing the aforementioned services to devices in the first network 800. The management server 200 may also connect with the first network 800 for providing a web portal of the services in the content server 150 or IoT device 250 to the terminal 400. In one embodiment of the present invention, the web portal of the services may comprise a web page containing network addresses of the services. The network addresses may comprise a virtualized host address representing the service portal and a data path of the services in the virtualized host (the service portal). The terminal 400 may send a request including at least one of the network addresses of the services to the management server 200. The content server 150 or the IoT device 250 may take the initiative to establish a connection with the relay server 300 and keep said connection. The management server 200 may further direct the request from the terminal 400 to the relay server 300. Therefore, the terminal 400 may send the request for the services to the content server 150 or IoT device 250 via the connection between the relay server 300 and the content server 150 or IoT device 250. Upon receiving the request from the relay server 300, the agents 900 in the content server 150 and the IoT device 250 may translate each of the network addresses in the request by mapping an actual host of the request service to the virtualized host address and generating a new network address containing the actual host address and the data path of the service respectively. The content server 150 and the IoT device 250 may retrieve data of the requested service respectively according to the generated new network address and send the data back to the terminal 400 via the relay server 300. In one embodiment of the present invention, the terminal 400 may receive a single web page containing the network addresses of the services in both the content server 150 and the IoT device 250, and may display a user interface containing the web page and the request services after receiving data of the services from the content server 150 and the IoT device 250.

Referring to FIG. 1F, the network device 100 may include a processor 101, a memory 102, a storage module 103 for storing services such as the first service 901 and the second service 902 and a communication module 104 for communicating with devices in the first network 800. In one embodiment of the present invention, the agent 900 depicted in FIGS. 1A to 1E may also be stored as a set of instructions in the storage module 103. The processor 101 may perform the instructions of the agent 900 to take an initiative to establish connection for communicating with the terminal 400, retrieve data of services requested by the terminal 400 and send back in response to the request from the terminal 400. Hence, the network device 100 may be any existing devices as long as storing the agent 900 in the storage module. In another embodiment of the present invention, the communication module 104 may also be able to communicate with devices in the second network 1100. The communication module 104 may communicate with devices in the first network 600 and the second network 600 in different protocols. Furthermore, the communication module 104 may include separate integrated circuit for communication in said different protocols.

The network device 100 of the present invention may be any device with network access especially the internet access and storage for storing data of services, including but not limited to a work station, a modem, a gateway, a router, a proxy server, a wireless access point, a wireless hot spot, a femtocell, a pico base station, a small cell, an Internet TV, and a set-up box. In one embodiment of the present invention may be content server 150, such as a network-attached storage (NAS) or a storage area network (SAN), etc. In one embodiment of the present invention, the IoT device 250 may comprise at least one sensor which may either be an image sensor, temperature sensor, or electricity sensor, etc. In one embodiment of the present invention, the IoT device 250 may comprise at least one actuator which may be actuated by a least one control such as a temperature control, a light control, an air control or a camera motor, etc. In one embodiment of the present invention, the IoT device 250 may comprise at least one sensor and at least one actuator, wherein the sensor may be an image sensor, temperature sensor, or electricity sensor, etc, and the actuator may either be actuated by a temperature control, a light control, an air control, a camera motor, etc.

Referring to FIG. 1G, an agent 900 may include a front-end module 950, a service retrieve module 953 and a translate module 954. The front-end module 950 may include a relay unit 951 and a P2P unit 952 for receiving the service requested by the terminal 400. Moreover, the relay unit 951 or the P2P unit 952 may receive the service requested by the terminal 400 through the management server 200 and send the request to the service retrieve module 953. Thereby, the service retrieve module 953 may send the request for the service to the network device 100 and send back the service to the terminal 400 via the front-end module 950. The translate module 954 may translate the first network address of the service requested by the terminal 400 to the second network address to retrieve the service from the network device 100. In one embodiment of the present invention, the service requested may be in the network device 100, the application server 1000 or any devices in the second network 1100.

In one embodiment of the present invention, the agent 900 may be any software/firmware or the devices Implemented with the aforementioned software/firmware having front-end module 950 for performing the function of taking initiative to establish connection for communication with the terminal 400 for receiving request from the terminal 400, retrieving requested contents/services available to the service retrieve module 953, translating the first network address to the second network address available to the translate module 954 and returning the contents/services in response to the request via the established connection. The contents/services may be in the network device 100, the content server 150 or the IoT device 250.

In one embodiment of the present invention, the agent 900 may take an initiative to connect with the relay server 300 for data exchange through the relay server 300 to providing contents/services to the terminal 400 in the first network 600. In another embodiment of the present invention, the agent 900 may exchange the IP address and the port number available for connection of the network device 100 for the IP address and the port number available for connection of the terminal 400 via the management server 200. Therefore, the network device 100 and the terminal 400 may connect with each other for data exchange through the relay server 300 to providing contents/services to the terminal 400 in the first network 600.

The management server 200 and the relay server 300 of the present invention may be a server, a plurality of servers in a server cluster or a data center respectively. In one embodiment of the present invention, the management server 200 and the relay server 300 may be a virtual machine, a plurality of virtual machines sharing cloud computing resources. In addition, the application server 1000 of the present invention may be a server, a plurality of servers in a server group or a data center. Also, the application server 1000 may also be a virtual machines or a plurality of virtual machines sharing cloud computing resources. Furthermore, in one embodiment of the present invention, the management server 200, the relay server 300 and the application server 100 may be a plurality of servers in the same server group or the same data center. The management server 200, the relay server 300 and the application server 100 may be a plurality of virtual machines sharing the same cloud computing resources. That is, the management server 200 and the relay server 300 may provide a platform for running the application server 1000.

The terminal 400 of the present invention may be any computing device with network connectivity especially the internet access, such as a desktop computer, a laptop computer, a tablet computer, a smart phone, an e-book reader, a smart television, a set-top box or a wearable device including a smart watch, a smart glass and a smart hand belt etc.

The firewall 500 may be implemented in a device or a computer program comprising instructions for to prevent unauthorized access into the network device 100. In one embodiment of the present invention, the firewall 500 may be implemented in the network device 100 as an integrated circuit or a computer program in the storage module 103 or another storage device.

The first NAT 600 and the second NAT 700 may be a device with network address translation, such as a gateway, a router, a wireless share point, a base station in telecommunication system including a pico base station, a femtocell, or a small cell between the first network 600 and the network device 100 or the terminal 400 respectively. In one embodiment of the present invention, the first NAT 600 and the second NAT may serve as the intersection points of an open network and a closed network, a wide area network (WAN) and a local area network (LAN), an extranet and an intranet, or a public network or a private network. In addition, if the first network 600 is a type of the aforementioned networks, the network device 100 and the terminal 400 may be in the contrary type of the aforementioned networks. In one embodiment of the present invention, the first NAT 600 may be implemented in the network device 100 as an integrated circuit or a computer program in the storage module 103 or another storage device.

The first network 800 of the present invention may be any types of networks especially a wide area network (WAN), a telecommunication network or the Internet. The second network 1100 in the present invention may also be any types of networks including a wired or wireless local area network (LAN), a telecommunication network, a virtual private network or the Internet.

The first service 901 and the second service 902 of the present invention may include web pages, executable files, multimedia files, streaming data services or application programs. In one embodiment of the invention, the agent 900 may provide a web page with frames for the services available to the network device 100 such as the first service 901 or the second service 902 of the network device 100, the services from the camera 1200 in the second network 1100 or the services from the application server 1000.

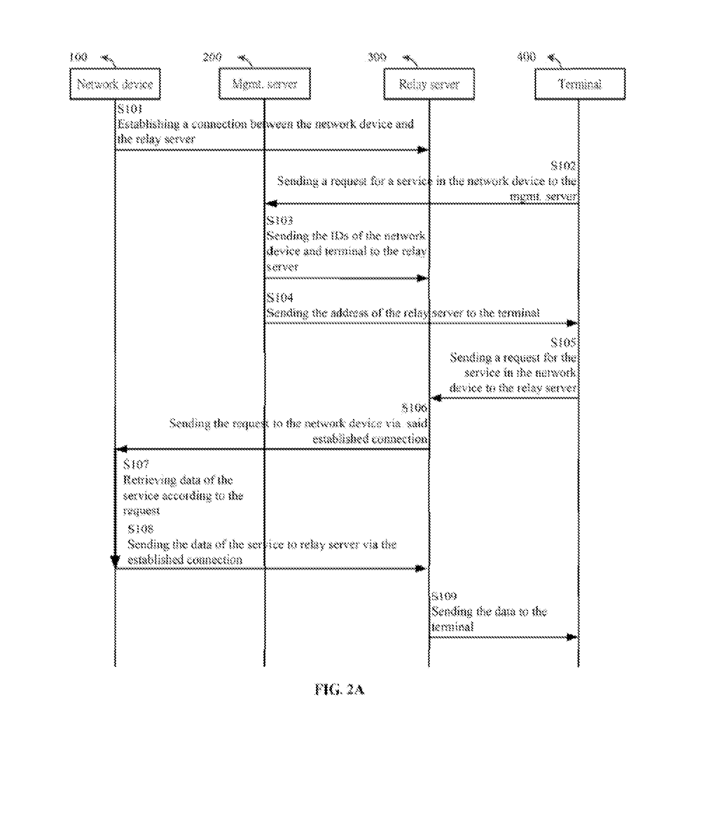

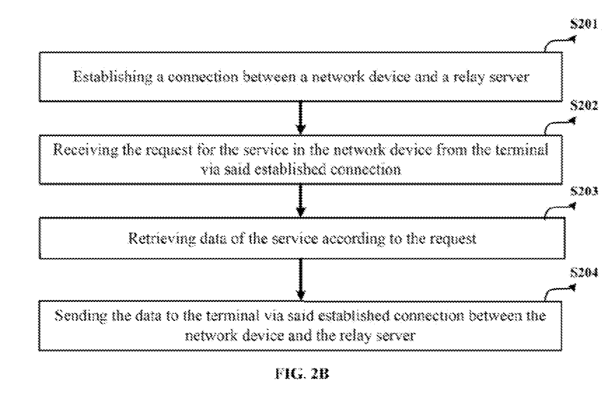

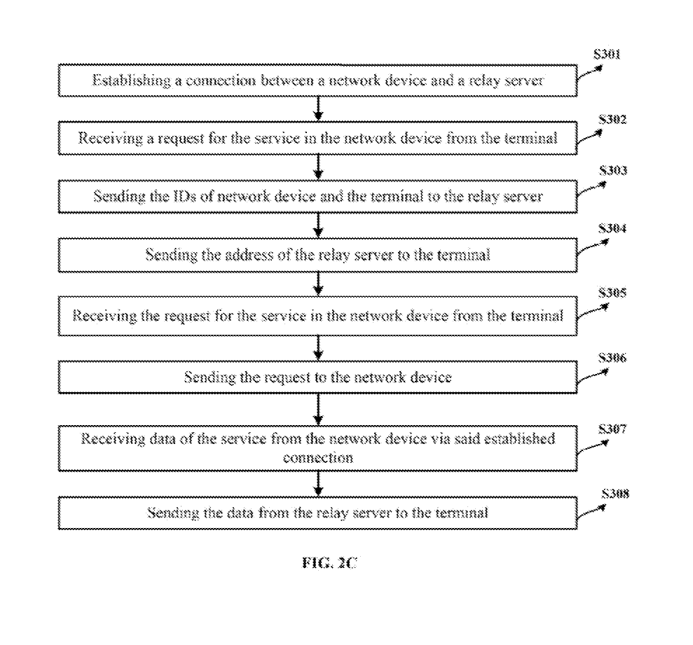

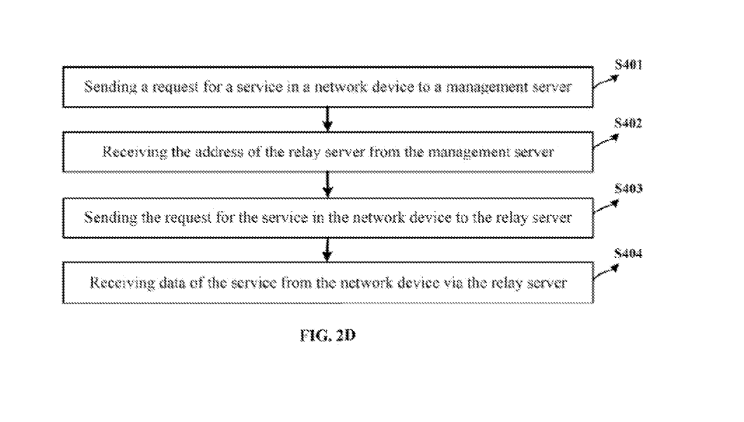

FIGS. 2A to 2D illustrate the method for providing services in a network device 100 to a terminal 400 and retrieving data of services from the network device 100 to the terminal 400 according to embodiments of the present invention.

FIG. 2A is a flowchart illustrating the method for retrieving data of services in the network device 100 according to one embodiment of the present invention, and the method of present invention may perform the following steps. In step S101, the network device 100 may establish a connection between the network device 100 and the relay server 300 and keep the connection. In one embodiment of the present invention, the network device 100 may take the initiative to communicate with the relay server 300 for preventing from being blocked by the firewall 500. In step S102, the terminal 400 may send a request for the service in the network device 100 to the management server 200. In one embodiment of the present invention, the request may include the identification of the terminal 400 (the terminal ID) and the identification of the network device 100 (the network device ID). Therefore, the management server may receive the network device ID and the terminal ID from the terminal 400. In one embodiment of the prevent invention, the network device 100 may periodically detect the connection between the network device 100 and the management server 200, and the network device 100 may send it's identification (the network device ID) to the management server 200 if said connection is established. The management server 200 may send the network device ID directly to the terminal 400 upon receiving the network ID. In step S103, the management server 200 may send the network device ID and the terminal ID to a relay server 300 for the relay server 300 checking the terminal ID and the network device ID while the terminal 400 attempting to connect with the network device 100 via the established connection between the network device 100 and the relay server 300. In step S104, the management server 200 may send the address of the relay server 300 to the terminal 400 for the terminal 400 requesting the network device 100 for the service via the relay server 300. In step S105, the terminal 400 may send the request including a network address corresponding to the service to the relay server 300 In step S106, the relay server 300 may send the request for the service to the network device 100 via the established connection between the network device 100 and the relay server 300. The agent 900 may translate a first network address of the service requested by the terminal 400 to a second network address to retrieve the service in the network device 100. For example, the agent 900 may translate the first network address “http://host.abc.com” to the second network address, such as “http://192.168.0.1”. In one embodiment of the present invention, each the network address may comprise a host address and a service directory information. In one embodiment of the present invention, the service directory information of the first network address and the second network address may be the same. For example, the first network address may be “http://host.abc.com/service.html” and the second network address may be “http://192.168.0.1/service.html”. Therefore, the host address of the first network address “host.abc.com” and the service directory information “service.html” and the host address of the second network address http://192.168.0.1 and the service directory information “service.html”. In one embodiment of the present invention, the network device 100 may further verify the terminal ID and the network device ID when the network device 100 receives the request of the terminal 400 from the relay server 300. In step S107, the network device 100 may retrieve a web page of the service corresponding to the request from the relay server 300. In one embodiment of the present invention, the network device 100 may retrieve an executable file, streaming data, a document or other types of a file corresponding to the requested service instead of the aforementioned web page. In step S108, the network device 100 may send the page of the service back to the relay server 300 via said established connection. In one embodiment of the present invention, the network device 100 may perform instructions from the agent 900 to receive the request, retrieve the web page according to the request and send to the relay server 300. In step S109, the relay server 300 may send the data of the service to the terminal 400. While the methods previously described may include a number of steps that may appear to occur in a specific order, it should be appreciated that these methods may contain more or fewer steps, that the order these steps may be exchanged, and that different steps may be combined. For example, the step S103 may be omitted or the steps S103 and S104 may be exchanged.

FIG. 2B illustrates the method for providing data of services in the network device 100 to the terminal 400 according to one embodiment of the present invention, and the method may be implemented as a set of instructions, in one embodiment of the present invention, the agent 900, in the network device 100. The method may perform the following steps. In step S201, the network device 100 may connect with the relay server 300 and keep the connection between the network device 100 and the relay server 300. In one embodiment of the present invention, the network device 100 may take the initiative to establish the connection for preventing from the relay server 300 being blocked by the firewall 500. In step S202, the network device 100 may receive the request in the network device 100 for the service from the terminal 400 via said established connection between the network device 100 and the relay server 300. In step S203, the network device 100 may retrieve data of the requested service such as a web page, an executable file, streaming data, a document or other types of files. In step S204, the network device 100 may send the data of the requested service to the relay server 300 via said established connection between the network device 100 and the relay server 300.

FIG. 2C illustrates the method for providing data of services in the network device 100 to the terminal 400 according to one embodiment of the present invention, and the method may perform the following steps. In step S301, the relay server 300 may establish a connection between the network device and itself. In one embodiment of the present invention, the relay server 300 may receive a request for connection from the network device 100 through the firewall 500, and keep the connection with the network device 100 according to the request. In one embodiment of the present invention, the management server 200 may receive the identification of the network device 100 (the network ID) for verification before the relay server 300 keeping the connection with the network device 100. In step S302, the management server 200 may receive a request for a service in the network device 100 from the terminal 400. In one embodiment of the present invention, the management server 200 may also receive the identification of the terminal 400 (the terminal ID). In step S303, the management server 200 may send the network device ID and the terminal ID to the relay server 300 for the relay server 300 checking the terminal ID and the network device ID while the terminal 400 attempting to connect with the network device 100 via said connection between the network device 100 and the relay server 300. In step S304, the management server 200 may send the address of the relay server 300 to the terminal 400 in response to the request from the terminal 400. In step S305, the relay server 300 may receive a request including a network address corresponding to the service in the network device 100 from the terminal 400. In step S306, the relay server 300 may send the request to the network device 100 via the established connection between the network device 100 and the relay server 300. In step S307, the relay server 300 may receive data of the service such as a web page, streaming data, an executable file, a document or other types of files from the network device 100 via the established connection. In step S308, the relay server 300 may send the data of the service to the terminal 400. Therefore, services in the network device 100 may be provided to the terminal 400 according to requests from the terminal 400. While the methods previously described may include a number of steps that may appear to occur in a specific order, it should be appreciated that these methods may contain more or fewer steps, that the order these steps may be exchanged, and that different steps may be combined. For example, the step S303 may be omitted or the steps S303 and S304 may be exchanged.

FIG. 2D illustrates the method for retrieving data of services from the network device 100 according to one embodiment of the present invention, and the method may be implemented in the terminal 400 according to one embodiment of the present invention. The method may perform the following steps. In step S401, the terminal 400 may send a request for a service in the network 100 to the management server 200. In step S402, the terminal 400 may receive an address of a relay server 300 from the management server 200 in response to the request. In step S403, the terminal 400 may send the request for the service to the relay server 300. In step S404, the terminal 400 may receive data of the service such as a web page, streaming data, an executable file, a document or other types of files in the network device 100 from relay server 300.

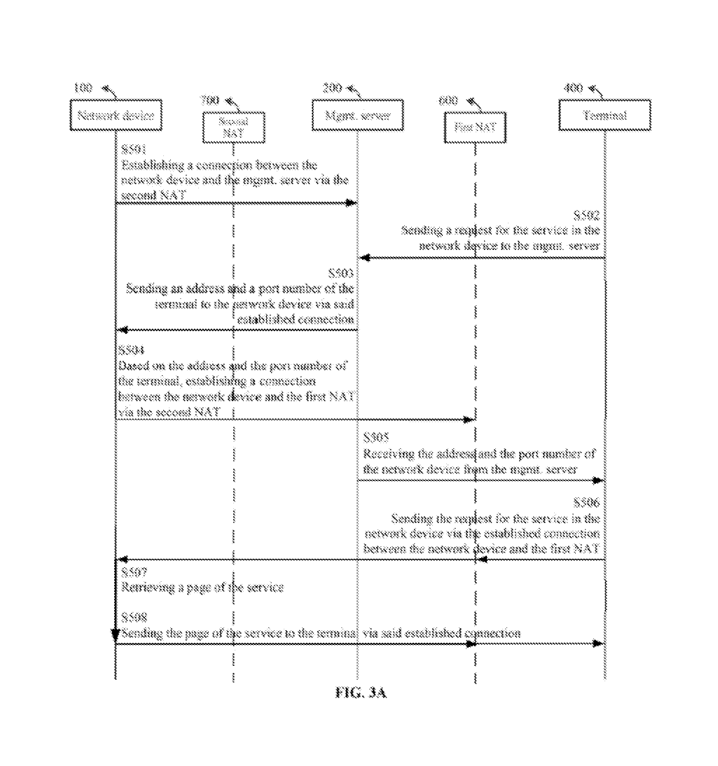

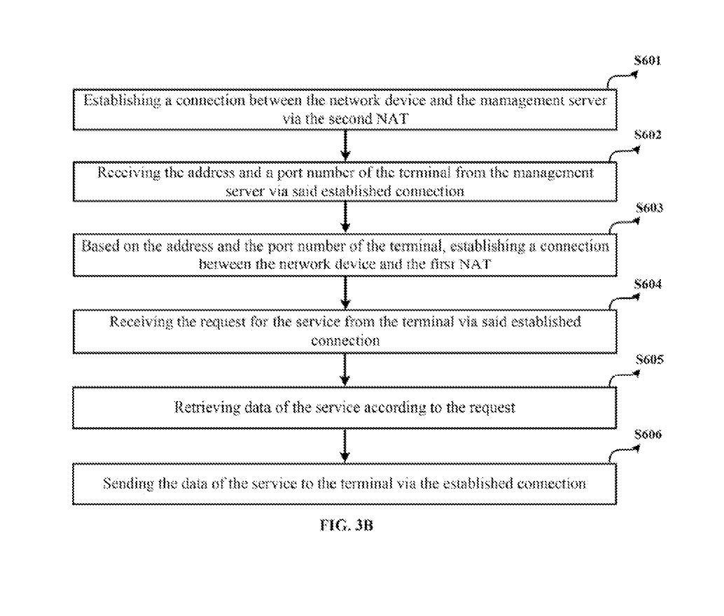

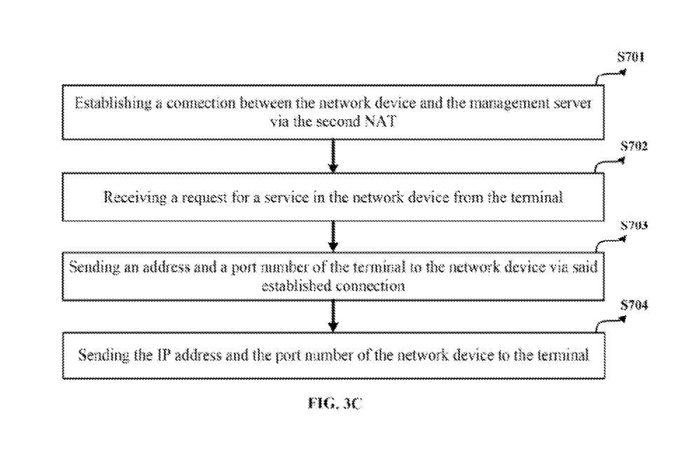

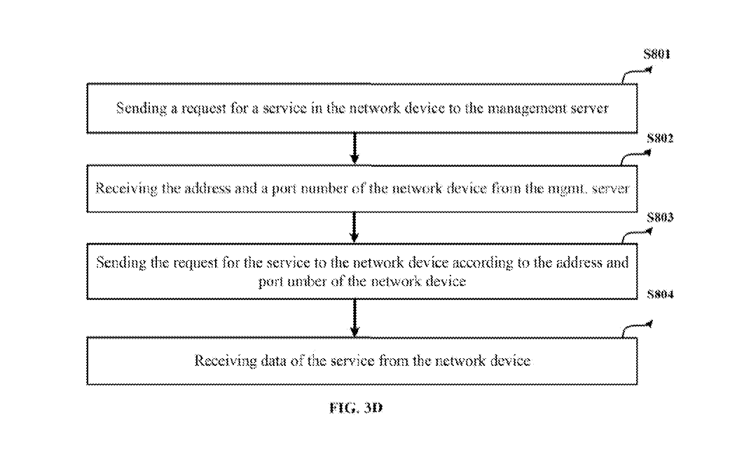

FIGS. 3A to 3D illustrate the method for providing services in a network device 100 to a terminal 400 and retrieving data of services from the network device 100 to the terminal 400 according to embodiments of the present invention.

FIG. 3A is a flow chart illustrating the method for retrieving data of services in the network device 100 according to one embodiment of the present invention, and the method of present invention may perform the following steps. In step S501, the network device 100 may establish a connection with the management server 200 and keep the connection between the network device 100 and the management server 200. In one embodiment of the present invention, the network device may take the initiative to connect with the management server 200 to prevent the management server 200 being blocked by the firewall 500 and the second NAT 700. In one embodiment of the present invention, the management server 200 may also receive the identification and a port number available for communication of the network device 100. In step S502, the terminal 400 may send a request for a service in the network device 100 to the management server 200. In one embodiment of the present invention, the management server 200 may also receive the identification and a port number available for communication of the terminal 400. In step S503, the management server 200 may send the address and the port number of the terminal 400 to the network device 100 via the established connection between the network device 100 and the management device 200. In step S504, the network device 100 may establish a connection between the network device 100 and the first NAT 600 based on the address and the port number of the terminal 400. In one embodiment of the present invention, the network device 100 may take the initiative to connect with the terminal 400 without being blocked by the second NAT 700 and establish at least the connection between the network device 100 and the first NAT 600. In step S505, the management server 200 may send the address and the port number of the network device 100 to the terminal 400. In one embodiment of the present invention, the address and the port number may be received in step S501. In step S506, the terminal 400 may send the request including a network address corresponding to the service available to the network device 100 via the established connection between the network device 100 and the first NAT 600 according to the address and the port number of the network device 100. The agent 900 may translate a first network address of the service requested by the terminal 400 to a second network address to retrieve the service in the network device 100. For example, the agent 900 may translate the first network address “http://host.abc.com” to the second network address, such as “http://192.168.0.1”. In one embodiment of the present invention, each the network address may comprise a host address and a service directory information. In one embodiment of the present invention, the service directory information of the first network address and the second network address may be the same. For example, the first network address may be “http://host.abc.com/service.html” and the second network address may be “http://192.168.0.1/service.html”. Therefore, the host address of the first network address “host.abc.com” and the service directory information “service.html” and the host address of the second network address http://192.168.0.1 and the service directory information “service.html”. In step S507, the network device 100 may retrieve a web page of the service in response to the request. In one embodiment of the present invention, the network device 100 may retrieve streaming data, an executable file, a document or other types of files instead. In step S508, the network device 100 may send the web page to the terminal 400 via said established connection between the network device 100 and the first NAT 600. In one embodiment of the prevent invention, the network device 100 may retrieve data of services from different devices, such as camera 1200 in the second network 1100. In another embodiment of the prevent invention, if the terminal 400 does not receive the requested services, the terminal 400 may send a notice to the management server 200 and activate the steps in FIG. 2A for retrieving data of the requested services from the network device 100. While the methods previously described may include a number of steps that may appear to occur in a specific order, it should be appreciated that these methods may contain more or fewer steps, that the order these steps may be exchanged, and that different steps may be combined. For example, in step S504, the network device 100 may establish a connection between with the terminal without being blocked by the first NAT 600 and the second NAT 700, and therefore the step S505 and S506 may be omitted. For another example, the management server 200 may further receive the identifications of the network device 100 and the terminal 400 for verification before sending the addresses to the network device 100 and the terminal 400 in steps S503 and S505.

FIG. 3B illustrates the method for providing services in the network device 100 to a terminal 400 according to one embodiment of the present invention, and the method may be implemented as a set of instructions, in one embodiment of the present invention, the agent 900, in the network device 100. The method may perform the following steps. In step S601, the network device 100 may establish a connection with the management server 200 and keep the connection. In one embodiment of the present invention, the network device 100 may take the initiative to connect with the management server 200 to prevent the management server 200 from being blocked by the firewall 500 and the second NAT 700. In step S602, the network device 100 may receive the address and a port number available for connection of the terminal 400 from the management server 200 via said established connection. In step S603, the network device 100 may establish a connection between the network device 100 and the first NAT 600 based on the address and the port number of the terminal 400. In one embodiment of the present invention, the network device 100 may take the initiative to connect with the terminal 400 without being blocked by the second NAT 700 and establish at least the connection between the network device 100 and the first NAT 600. In step S604, the network device 100 may receive the request for the service from the terminal 400 via said established connection. In step S605, the network device 100 may retrieve data of the service according to the request. In step S606, the network device 100 may send the data of the service to the terminal 400 via said established connection between the network device 100 and the first NAT 600.

FIG. 3C illustrates the method for providing data of services in the network device 100 to the terminal 400 according to one embodiment of the present invention, and the method may perform the following steps. In step S701, the management server 200 may establish a connection between the network device 100 and itself. In one embodiment of the present invention, the management server 200 may receive a request for connection from the network device 100 via the second NAT 700, and keep the connection with the network device 100 according to the request. In step S702, the management server 200 may receive a request for a service in the network device 100 from the terminal 400. In step S703, the management server 200 may send the address and a port number available for connection of the terminal 400 to the network device 100 via said established connection between the network device 100 and the management server 200. In step S704, the management server 200 may send the address and a port number available for connection of the network device 100 to the terminal 400. By performing steps S703 and S704, the terminal 400 and the network device 100 may both take the initiative to communication with each other for data exchange without being blocked by the first NAT 600 and the second NAT 700. Therefore, the terminal 400 may send the request for the service to the network device 100 and receive data of the service from the network device 100.

FIG. 3D illustrates the method for retrieving data of services from the network device 100 according to one embodiment of the present invention, and the method may be implemented in the terminal 400 according to one embodiment of the present invention. In step S801, the terminal 400 may send a request for a service in the network device 100 to the management server 200. In step S802, the terminal 400 may receive the address and a port number available for communication of the network device 100 from the management server 200 as a response to the request. In step S803, the terminal 400 may send a request including a network address corresponding to the service available to the network device 100 according to the address and the port number of the network device 100 received from the management server 200. In one embodiment of the present invention, the network device 100 may also receive the address and a port number available for connection of the terminal 400 from the management server 200 and take the imitative to establish and keep a connection at least with the first NAT 600. The terminal 400 may send the request for the server to the network device 100 via said connection between the network device 100 and the first NAT 600. In step S804, the terminal 400 may receive data of the requested service from the network device. In one embodiment of the present invention, by sending the request to the network device 100, the terminal 400 may establish and keep a connection between with at least the second NAT 700 for the network device 100 sending data of the requested service to the terminal 400. The terminal 400 may receive the data from the network device 100 via the established connection. Therefore, the terminal may request the management server 200 for services of the network device 100 and retrieve data of the requested service from the network device 100.

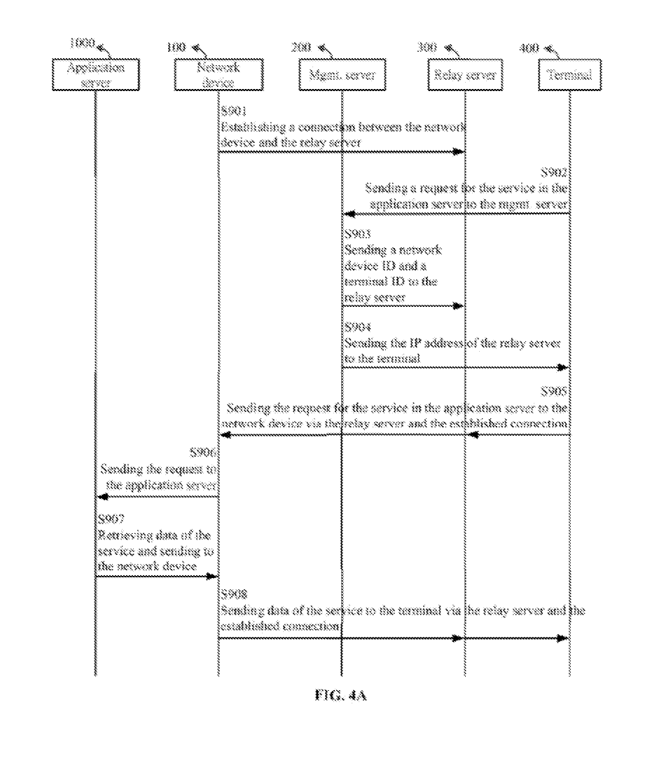

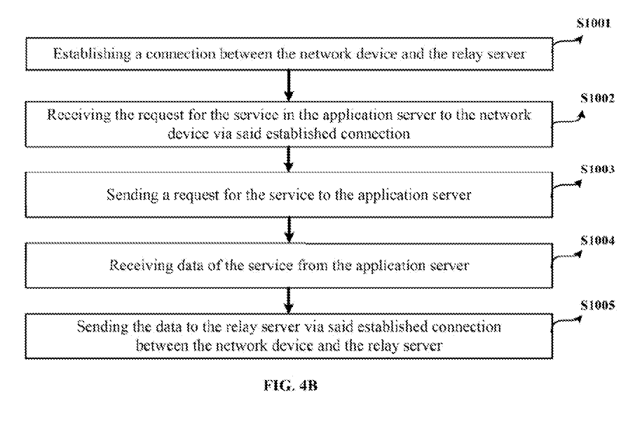

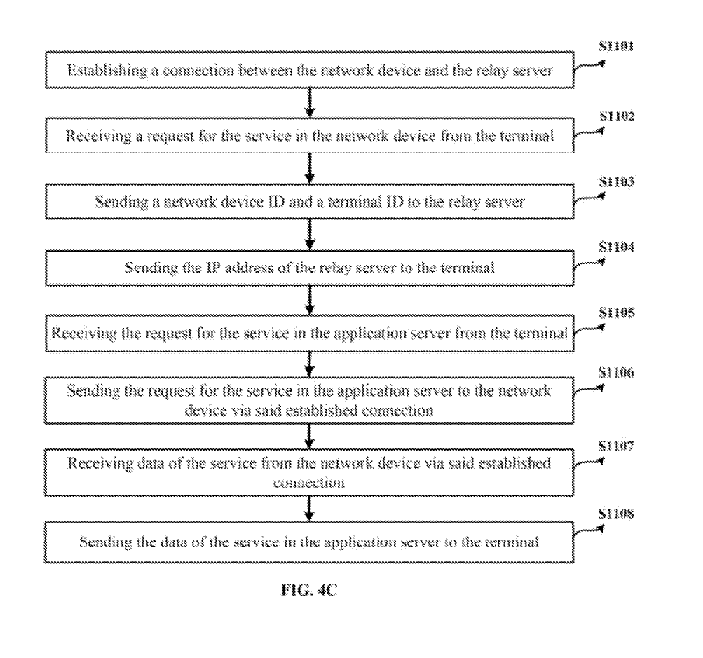

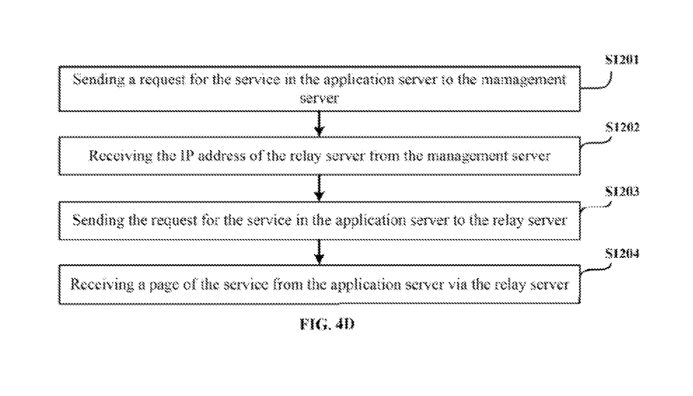

FIGS. 4A to 4D illustrate the method for providing services in an application server 1000 to a terminal 400 and retrieving data of services from the network device 100 to the terminal 400 according to embodiments of the present invention.

FIG. 4A is a flowchart illustrating the method for retrieving data of services in an application server 1000 from a network device 100 according to one embodiment of the present invention, and the method of present invention may perform the following steps. In step S901, the network device 100 may establish a connection between the network device 100 and the relay server 300 and keep the connection. In one embodiment of the present invention, the network device 100 may take the initiative to communicate with the relay server 300 for preventing from being blocked by the firewall 500. In step S902, the terminal 400 may send a request for the service in application server 1000 to the management server 200. In one embodiment of the present invention, the request may include the identification of the terminal 400 (the terminal ID) and the identification of the network device 100 (the network device ID). Therefore, the management server may receive the network device ID and the terminal ID from the terminal 400. In one embodiment of the prevent invention, the network device 100 may periodically detect the connection between the network device 100 and the management server 200, and the network device 100 may send it's identification (the network device ID) to the management server 200 if said connection is established. The management server 200 may send the network device ID directly to the terminal 400 upon receiving the network ID. In step S903, the management server 200 may send the network device ID and the terminal ID to a relay server 300 for the relay server 300 checking the terminal ID and the network device ID while the terminal 400 attempting to connect with the network device 100 via the established connection between the network device 100 and the relay server 300. In step S904, the management server 200 may send the address of the relay server 300 to the terminal 400 for the terminal 400 requesting the network device 100 for the service via the relay server 300. In Step S905, the terminal 400 may send the request including a network address corresponding to the service to the relay server 300 according to the address of the relay server 300. In addition, the relay server 300 may send the request for the service to the network device 100 via the established connection between the network device 100 and the relay server 300. The agent 900 may translate a first network address of the service requested by the terminal 400 to a second network address to retrieve the service in the application server 1000. For example, the agent 900 may translate the first network address “http://host.abc.com” to the second network address, such as “http://192.168.0.1”. In one embodiment of the present invention, each the network address may comprise a host address and a service directory information. In one embodiment of the present invention, the service directory information of the first network address and the second network address may be the same. For example, the first network address may be “http://host.abc.com/service.html” and the second network address may be “http://192.168.0.1/service.html”. Therefore, the host address of the first network address “host.abc.com” and the service directory information “service.html” and the host address of the second network address http://192.168.0.1 and the service directory information “service.html”. In one embodiment of the present invention, the network device 100 may further verify the terminal ID and the network device ID when the network device 100 receives the request of the terminal 400 from the relay server 300. In step S906, the network device 100 may send a request for the service according to the request to the application server 1000. In step S907, the application server 1000 may retrieve data of the requested service and send back to the network device 100. In one embodiment, the data may include a web page, an executable file, streaming data, a document or other types of a file corresponding to the requested service. In step S908, the network device 100 may send the data of the service back to the relay server 300 via said established connection. In one embodiment of the present invention, the network device 100 may perform instructions from the agent 900 to receive the request, retrieve the data according to the request and send to the relay server 300. In addition, the relay server 300 may send the data of the service to the terminal 400. While the methods previously described may include a number of steps that may appear to occur in a specific order, it should be appreciated that these methods may contain more or fewer steps, that the order these steps may be exchanged, and that different steps may be combined. For example, the step S903 may be omitted or the steps S103 and S104 may be exchanged.

FIG. 4B illustrates providing data of services in the network device 100 to the terminal 400 according to one embodiment of the present invention, and the method may be implemented as a set of instructions, in one embodiment of the present invention, the agent 900, in the network device 100. The method may perform the following steps. In step S1001, the network device 100 may connect with the relay server 300 and keep the connection between the network device 100 and the relay server 300. In one embodiment of the present invention, the network device 100 may take the initiative to establish the connection for preventing from the relay server 300 being blocked by the firewall 500. In step S1002, the network device 100 may receive the request in the network device 100 for the service from the terminal 400 via said established connection between the network device 100 and the relay server 300. In step S1003, the network device 100 may send a request for the service to the application server 1000. In step S1004, the network device may receive data of the requested service such as a web page, an executable file, streaming data, a document or other types of files. In step S1005, the network device 100 may send the data of the requested service to the relay server 300 via said established connection between the network device 100 and the relay server 300. Thereby, a terminal 400 may send its request for the service in the application server 1000 to the network device 100 and receive data of the service from the network device via the relay server 300.

FIG. 4C illustrates the method for providing data of services in the network device 100 to the terminal 400 according to one embodiment of the present invention, and the method may perform the following steps. In step S1101, the relay server 300 may establish a connection between the network device 100 and itself In one embodiment of the present invention, the relay server 300 may receive a request for connection from the network device 100 through the firewall 500, and keep the connection with the network device 100 according to the request. In one embodiment of the present invention, the management server 200 may receive the identification of the network device 100 (the network ID) for verification before the relay server 300 keeping the connection with the network device 100. The network device 100 may further send the address of the relay server 300 to the network device 100 after verification. In step S1102, the management server 200 may receive a request for a service in the application server 1000 from the terminal 400. In one embodiment of the present invention, the management server 200 may also receive the identification of the terminal 400 (the terminal ID). In step S1103, the management server 200 may send the network device ID and the terminal ID to the relay server 300 for the relay server 300 checking the terminal ID and the network device ID while the terminal 400 attempting to connect with the network device 100 via said connection between the network device 100 and the relay server 300. In step S1104, the management server 200 may send the address of the relay server 300 to the terminal 400 in response to the request from the terminal 400. In step S1105, the relay server 300 may receive a request for the service in the network device 100 from the terminal 400. In step S1106, the relay server 300 may send the request including a network address corresponding to the service available to the network device 100 via the established connection between the network device 100 and the relay server 300. In step S1107, the relay server 300 may receive data of the service such as a web page, streaming data, an executable file, a document or other types of files from the network device 100 via the established connection. In step S1108, the relay server 300 may send the data of the service to the terminal 400. Therefore, services in the application server 1000 may be provided to the terminal 400 according to requests from the terminal 400. While the methods previously described may include a number of steps that may appear to occur in a specific order, it should be appreciated that these methods may contain more or fewer steps, that the order these steps may be exchanged, and that different steps may be combined. For example, the step S1103 may be omitted or the steps S1103 and S1104 may be exchanged.

FIG. 4D illustrates the method for retrieving data of services in the application server 1000 from the network device 100 according to one embodiment of the present invention, and the method may be implemented in the terminal 400 according to one embodiment of the present invention. The method may perform the following steps. In step S1201, the terminal 400 may send a request for a service in the application server 1000 to the management server 200. In step S1202, the terminal 400 may receive an address of a relay server 300 from the management server 200 in response to the request. In step S 1203, the terminal 400 may send the request for the service to the relay server 300. In step S1204, the terminal 400 may receive data of the service such as a web page, streaming data, an executable file, a document or other types of files in the network device 100 from relay server 300.

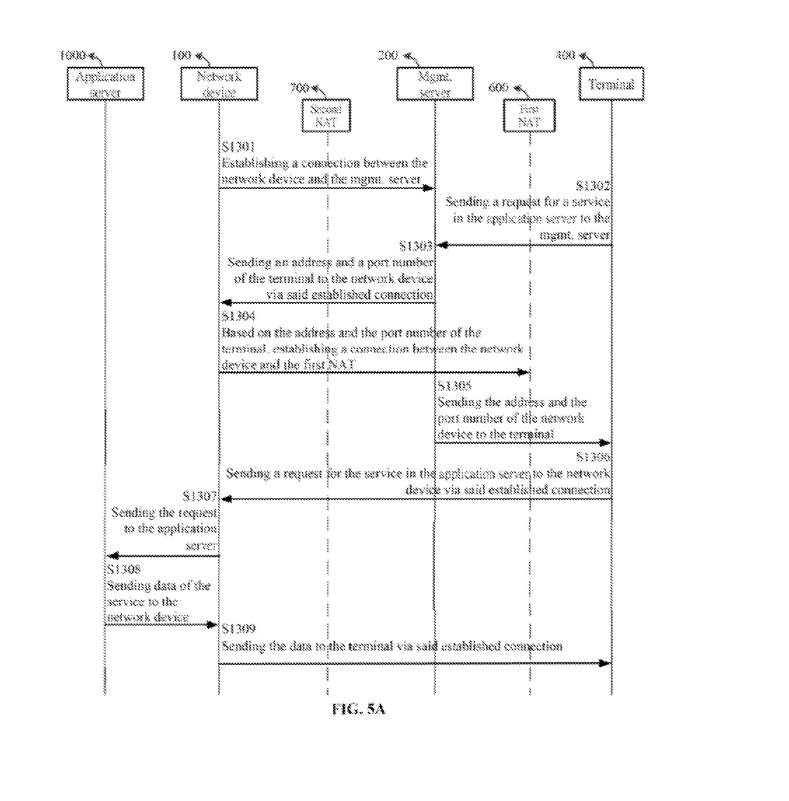

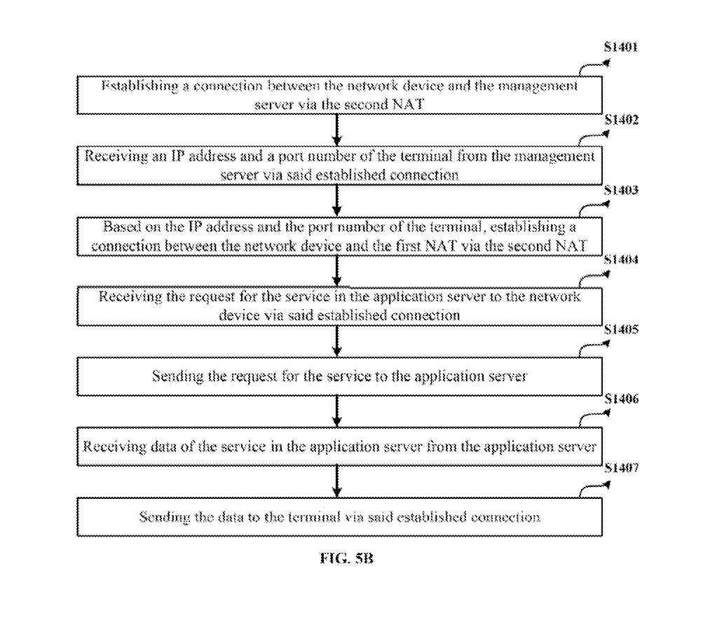

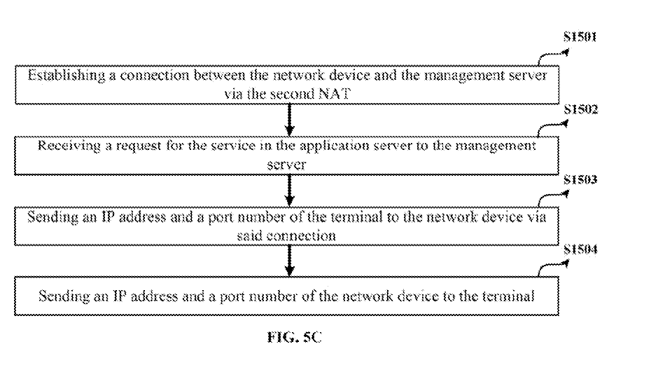

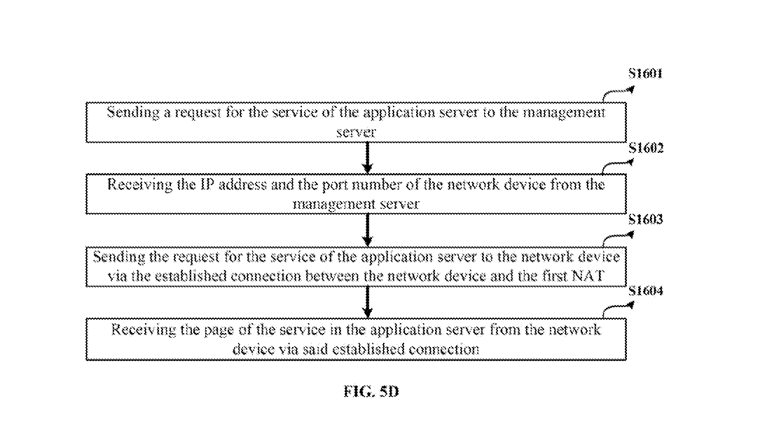

FIGS. 5A to 5D illustrate the method for providing services in an application server 1000 to a terminal 400 and retrieving data of services from the network device 100 to the terminal 400 according to embodiments of the present invention.

FIG. 5A is a flow chart illustrating the method for retrieving data of services in the network device 100 according to one embodiment of the present invention, and the method of present invention may perform the following steps. In step S1301, the network device 100 may establish a connection with the management server 200 and keep the connection between the network device 100 and the management server 200. In one embodiment of the present invention, the network device may take the initiative to connect with the management server 200 to prevent the management server 200 being blocked by the firewall 500 and the second NAT 700. In one embodiment of the present invention, the management server 200 may also receive the identification and a port number available for communication of the network device 100. In step S1302, the terminal 400 may send a request for a service in application server to the management server 200. In one embodiment of the present invention, the management server 200 may also receive the identification and a port number available for communication of the terminal 400. In step S1303, the management server 200 may send the address and the port number of the terminal 400 to the network device 100 via the established connection between the network device 100 and the management device 200. In step S1304, the network device 100 may establish a connection between the network device 100 and the first NAT 600 based on the address and the port number of the terminal 400. In one embodiment of the present invention, the network device 100 may take the initiative to connect with the terminal 400 without being blocked by the second NAT 700 and establish at least the connection between the network device 100 and the first NAT 600. In step S1305, the management server 200 may send the address and the port number of the network device 100 to the terminal 400. In one embodiment of the present invention, the address and the port number may be received in step S1301. In step S1306, the terminal 400 may send the request to the network device 100 via the established connection between the network device 100 and the first NAT 600 according to a web page URL, which is an HTTP formatted request from the terminal 400, such as “http://host.abc.com”. In step S1307, the network device 100 may send the request to the application server 1000. The agent 900 may translate a first network address of the service requested by the terminal 400 to a second network address to retrieve the service in the application server 1000. For example, the agent 900 may translate the first network address “http://host.abc.com” to the second network address, such as “http://192.168.0.1”. In one embodiment of the present invention, each the network address may comprise a host address and a service directory information. In one embodiment of the present invention, the service directory information of the first network address and the second network address may be the same. For example, the first network address may be “http://host.abc.com/service.html” and the second network address may be “http://192.168.0.1/service.html”. Therefore, the host address of the first network address “host.abc.com” and the service directory information “service.html” and the host address of the second network address http://192.168.0.1 and the service directory information “service.html”. In step S1308, the application server 1000 may retrieve data of the service such as a web page, streaming data, an executable file, a document or other types of files. In step S1309, the network device 100 may send the data to the terminal 400 via said established connection between the network device 100 and the first NAT 600. In one embodiment of the prevent invention, if the terminal 400 does not receive the requested services, the terminal 400 may send a notice to the management server 200 and activate the steps in FIG. 4A for retrieving data of the requested services from the network device 100. While the methods previously described may include a number of steps that may appear to occur in a specific order, it should be appreciated that these methods may contain more or fewer steps, that the order these steps may be exchanged, and that different steps may be combined. For example, in step S1304, the network device 100 may establish a connection between with the terminal without being blocked by the first NAT 600 and the second NAT 700, and therefore the step S1305 and S1306 may be omitted. For another example, the management server 200 may further receive the identifications of the network device 100 and the terminal 400 for verification before sending the addresses to the network device 100 and the terminal 400 in steps S1303 and S1305.

FIG. 5B illustrates the method for providing services in the application server 1000 to a terminal 400 according to one embodiment of the present invention, and the method may be implemented as a set of instructions, in one embodiment of the present invention, the agent 900, in the network device 100. The method may perform the following steps. In step S1401, the network device 100 may establish a connection with the management server 200 and keep the connection. In one embodiment of the present invention, the network device 100 may take the initiative to connect with the management server 200 to prevent the management server 200 from being blocked by the firewall 500 and the second NAT 700. In step S1402, the network device 100 may receive the address and a port number available for connection of the terminal 400 from the management server 200 via said established connection. In step S1403, the network device 100 may establish a connection between the network device 100 and the first NAT 600 based on the address and the port number of the terminal 400. In one embodiment of the present invention, the network device 100 may take the initiative to connect with the terminal 400 without being blocked by the second NAT 700 and establish at least the connection between the network device 100 and the first NAT 600. In step S1404, the network device 100 may receive the request for the service from the terminal 400 via said established connection. In step S1405, the network device 100 may send the request for the service to the application server 1000. In step S1406, the network device 100 may receive data of the service from the application server 1000. In step S1407, the network device 100 may send the data of the service to the terminal 400 via said established connection between the network device 100 and the first NAT 600.

FIG. 5C illustrates the method for providing data of services in application server 1000 to the terminal 400 according to one embodiment of the present invention, and the method may perform the following steps. In step S1501, the management server 200 may establish a connection between the network device 100 and itself. In one embodiment of the present invention, the management server 200 may receive a request for connection from the network device 100 via the second NAT 700, and keep the connection with the network device 100 according to the request. In step S1502, the management server 200 may receive a request for a service in the application server 1000 from the terminal 400. In step S1503, the management server 200 may send the address and a port number available for connection of the terminal 400 to the network device 100 via said established connection between the network device 100 and the management server 200. In step S1504, the management server 200 may send the address and a port number available for connection of the network device 100 to the terminal 400. By performing steps S1503 and S1504, the terminal 400 and the network device 100 may both take the initiative to communication with each other for data exchange without being blocked by the first NAT 600 and the second NAT 700. Therefore, the terminal 400 may send the request for the service to the network device 100 and receive data of the service from the network device 100.

FIG. 5D illustrates the method for retrieving data of services in the application server 1000 from the network device 100 according to one embodiment of the present invention, and the method may be implemented in the terminal 400 according to one embodiment of the present invention. In step S1601, the terminal 400 may send a request for a service in the application server 1000 to the management server 200. In step S1602, the terminal 400 may receive the address and a port number available for communication of the network device 100 from the management server 200 as a response to the request. In step S1603, the terminal 400 may send a request for the service to the network device 100 according to the address and the port number of the network device 100 received from the management server 200. In one embodiment of the present invention, the network device 100 may also receive the address and a port number available for connection of the terminal 400 from the management server 200 and take the initiative to establish and keep a connection at least with the first NAT 600. The terminal 400 may send the request for the server to the network device 100 via said connection between the network device 100 and the first NAT 600. In step S1604, the terminal 400 may receive data of the requested service from the network device according to a web page URL, which is an HTTP formatted request from the terminal 400, such as “http://host.abc.com”. In one embodiment of the present invention, by sending the request to the network device 100, the terminal 400 may establish and keep a connection between with at least the second NAT 700 for the network device 100 sending data of the requested service to the terminal 400. The terminal 400 may receive the data from the network device 100 via the established connection. Therefore, the terminal may request the management server 200 for services of the network device 100 and retrieve data of the requested service from the network device 100.

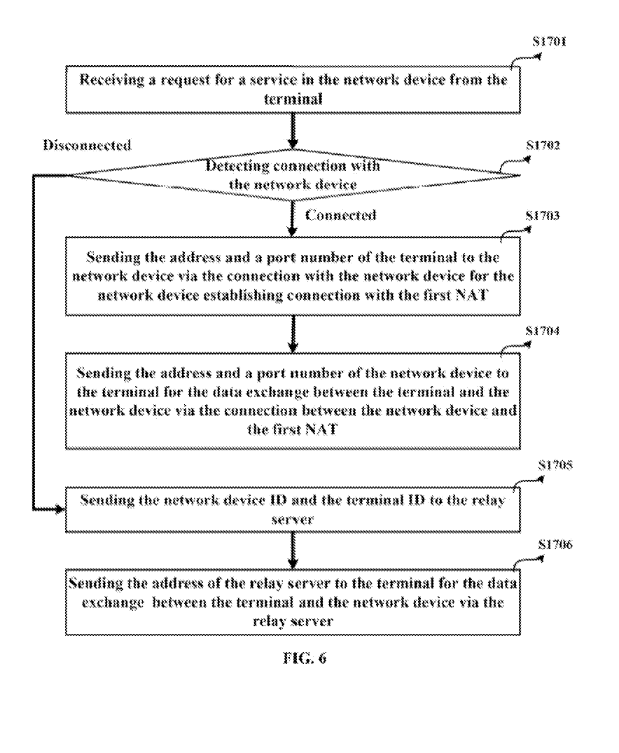

FIG. 6 is a flowchart illustrating the method for providing services in the network device 100 to a terminal 400 according to one embodiment of the present invention.

FIG. 6 illustrates the method for providing data of services in the network device 100 to the terminal 400 according to one embodiment of the present invention, and the method may perform the following steps. In step S1701, the management server 200 may receive a request for a service in the network device 100 from the terminal 400. In step S1702, the management server 200 may detect its connection with network device 100. If the management server 200 is connected with the network device 100, the management server 200 may perform the steps S1703 and S1704. In step S1703, the management server 200 may send the address and a port number available for connection of the terminal 400 to the network device 100 for the network device 100 to establish connection with first NAT 600. In step S1704, the management server 200 may send the address and a port number available for connection of the network device 100 to the terminal 400 for the terminal 400 establish connection with the second NAT 700 to enable data exchange between the terminal 400 and the network device. By performing steps S1703 and S1704, the terminal 400 and the network device 100 may both take the initiative to communication with each other for data exchange without being blocked by the first NAT 600 and the second NAT 700. Therefore, the terminal 400 may send the request for the service to the network device 100 and receive data of the service from the network device 100. In one embodiment of the present invention, if the management server 200 is disconnected from the network device 100, the management server 200 may perform the steps S1705 and S1706. In step S1705, the management server 200 may send the identification of the network device 100 and the terminal 400 to the relay server 300, and in step S1706, the management server 200 may send the address of the relay server 300 to the terminal 400 for the data exchange between the terminal 400 and the network device 100 via the relay server 300.

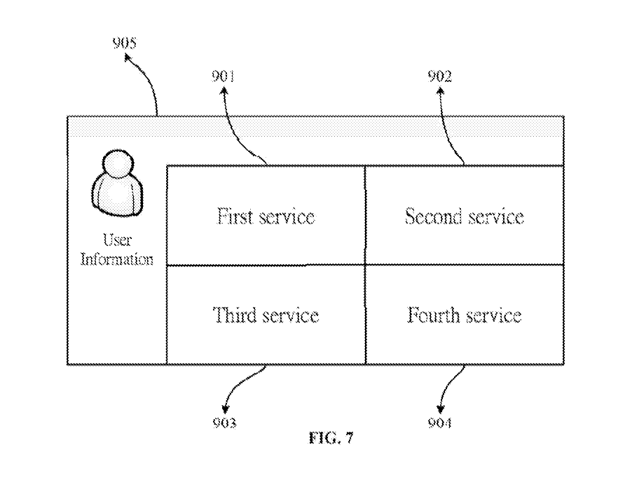

FIG. 7 schematically illustrates a web page provided by the network device 100 according to one embodiment of the present invention. Web page 905 may be a web page generated by the agent 900 in the network device 100 in response to a request for the first service 901, the second service 902, the third service 903 and the fourth service 904, and wherein the first service 901 and the second service 902 may be stored in the network device 100, and wherein the third service and the fourth services 903 and 904 may not be stored in the network device 100. For example, the third service 903 may be a service provided by the camera 1200 in the second network 1100, and the fourth service 904 may be a service provided by the application server 1000. The network device 100 may request and receive data of services 903 and 904. In addition, the web page 905 may comprise a plurality of frames for presenting the data of the services 901, 902, 903 and 904 respectively. In one embodiment of the present invention, the web page 905 may further include information related to the user of the terminal 400 such as the name or the identification of the user. The user information may be received from the management server 200 or the terminal 400 while the terminal 400 attempting to retrieve the services in the network device 100. Therefore, services from different host may be integrated and provided by the network device 100 according to one embodiment of the present invention.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A method for providing service to a client in a first network through a service portal in the first network, the method being implemented in a first network device in a first network, and the method comprising:
establishing a first connection between the first network device and the service portal;
receiving a first service request from the client via the first connection for a first service in a first network address, wherein the first network address includes a virtualized host address of the first service in the service portal and a first data path of the service in the virtualized host;
generating a second network address according to the first network address, wherein the second network address includes a first actual host address of the service and the first data path;
retrieving data of the first service according to the second network address; and
transmitting the data of the first service to the client.

2. The method according to claim 1, wherein the network device is the actual host of the service, and the second network address comprises the home address of the first network device.

3. The method according to claim 1, wherein the actual host of the service is an application server in the first network and the first network address includes the network address of the application server.

4. The method according to claiml, wherein the actual host of the service is a second network device in the second network and the second network address includes the network address of the second network device.

5. The method according to claim 1, further comprising:
receiving a second service request from the client via the connection for a second service in a third network address, wherein the third network address includes the virtualized host address of the second service in the service portal and a second data path of the second service in the virtualized host;
generating a fourth network address according to the third network address, wherein the fourth network address includes a second actual host address of the service and the second data path;
retrieving data of second service according to the fourth network address; and
transmitting the data of the second service to the client; and
wherein the data of the first and the second services are provided in a single page in the client device.

6. The method according to claim 1, further comprising:
receiving the address of the client and a port number for connection from the service portal via the established connection; and
establishing a second connection between the first network device and the client based on the address of the client and the port number; and
wherein the data of the first service is transmitted through the second connection.

7. The method according to claim 6, further comprising:
receiving a third service request for the first service from the service portal, wherein the service portal sends the third service request after receiving a fourth request for retransmitting the data of the first service from the client;
transmitting the data of the first service to the service portal; and
wherein the service portal transmits the data to the client upon receiving the data.

8. The method according to claim 1, wherein the data of the first device is transmitted to the service portal first, and the service portal then transmit the data to the client.

9. A non-transitory computer readable storage medium including instructions, which when executed by a computer system causes the computer system to perform operations for providing service to a client in a first network through a service portal in the first network, the operations comprising:
establishing a first connection between the first network device and the service portal;
receiving a first service request from the client via the first connection for a first service in a first network address, wherein the first network address includes a virtualized host address of the first service in the service portal and a first data path of the service in the virtualized host;
generating a second network address according to the first network address, wherein the second network address includes a first actual host address of the service and the first data path;
retrieving data of the first service according to the second network address; and
transmitting the data of the first service to the client.

10. A system for providing service in a first network to a client in a second network through a service portal, the system comprising:
a front-end module for establishing a connection with the service portal, receiving a service request from the client via the connection for a service in a first network address and transmitting data of the requested service to the client, wherein the first network address includes a virtualized host address of the first service in the service portal and a first data path of the service in the virtualized host;
an address generation module for generating a second network address according to the first network address, wherein the second network address includes a first actual host address of the service and the first data path; and
a service retrieving module for retrieving data of the first service according to the second network address.

11. A system for retrieving a first service in a second network through a service portal in a first network, the system comprising:
a user interface module for receiving a service page containing at least a first network address corresponding to the first service from the service portal, wherein the first network address includes a virtualized host address of the first service in the service portal and a first data path of the first service in the virtualized host;
a service requesting module for sending a first service request containing the first network address to the service portal for the first service; and
a data retrieving module for receiving a second network address of containing a first actual host address of the first service in the second network from the service portal, sending a second service request, based on the second network address and the first data path, to the first actual host for the first service and receiving data of the first service from the first actual host in the second network; and
wherein the user interface module further displays a user interface comprising the service page and the data of the first service.

12. The system according to claim 11, wherein the data retrieving module further determines whether to request the service from the service portal instead of the actual host; and
responsive to a determination to request the service from the service portal, the data retrieving module sends a third request for the service to the service portal and receives the data of the service from the service portal.

13. The system according to claim 11, wherein the service page further comprises a third network address corresponding to a second service from the service portal, wherein the third network address includes the virtualized host address of the second service in the service portal and a second data path of second first service in the virtualized host;
wherein the service request module further sends a fourth request containing the third network address to the service portal for the second service;
wherein the data retrieving module further receives a fourth network address of containing a second actual host address of the second service from the service portal, sends a fifth service request, based on the second network address and the second data path, to the second actual host and receives data of the second service from the second actual host; and
wherein the user interface displayed by the user interface module further comprises the data of the second service.

14. A method for providing service from a network device to a client through a service portal, the method being implemented in the service portal, wherein the client and the service portal is in a first network, and the network device is in a second network, and the method comprising:
establishing a first connection with the network device;
providing a service page including a first network address corresponding to a first service to the client, wherein the first network address includes a virtualized host address of the first service in the service portal and a first data path of the first service in the virtualized host;
receiving a first service request containing the first network address from the client for the first service; and
sending the first service request to the network device via the connection for the network device to retrieve data of the first service based on the first network address and to transmit the data to the client; and
wherein the network device generates a second network address including a first actual host address of the first service and the first data path and retrieves the data of the first service from the actual host based on the second network address.

15. The method according to claim 14, wherein the service page further includes a third network address corresponding to a second service, and the third network address includes the virtualized host address of the second service in the service portal and a second data path of the second service in the virtualized host, and the method further comprising:
receiving a second service request containing the third network address from the client for the second service; and
sending the second service request to the network device via the connection for the network device to retrieve data of the second service based on the third network address and to transmit the data of the second service to the client; and
wherein the network device generates a fourth network address including a second actual host address of the second service and the second data path and retrieves the data of the second service from the second actual host based on fourth network address.

16. The method according to claim 14, further comprising:
sending a fifth network address of the client to the network device for the network device attempting to establish a second connection between the network device and the client; and
sending a sixth network address of the network device to the client for the client to attempting to establish the second connection between the network device and the client; and
wherein the network device sends the data of the first service to the client via the established second connection.

17. The method according to claim 14, further comprising:
receiving the data of the first service from the network device via the first connection; and
transmitting the data of the first service to the client.

18. A network device for providing service to a client through a service portal in a first network, wherein the network device is in a second network, the network device comprising:
a memory;
a first communication module for establishing a connection with the service portal, receiving a service request from the client via the connection for a service in a first network address and transmitting data of the requested service to the client, wherein the first network address includes a virtualized host address of the first service in the service portal and a first data path of the service in the virtualized host; and
a processing unit coupled to the first communication module and the memory for generating a second network address according to the first network address and retrieving data of the service according to the second network address, wherein the second network address includes a first actual host address of the service and the first data path.

19. The network device of claim 18, further comprising a second communication module for retrieving data of the service according to the second network address based on a set of instructions from the processing unit.

20. The network device of claim 18, further comprising a sensing module for collecting data from environment as the data of the service.

21. The network device of claim 18, further comprising an actuating module for performing actions based on a set of instructions from the processing unit; and
wherein the service request comprising a command for performing an action;
wherein the processing unit further generates a set of instructions for performing the action according to the command and sends the instructions to the actuating module; and
wherein the actuating module further generates result data while performing the action as the data of the service.
